(19) United States
(12) Patent Application Publication
(10) Pub. No.: US 2008/0187698 A1
(43) Pub. Date: Aug. 7, 2008

(54) Fabricated composite fuel tank

(76) Inventors: Christopher Brown, Merritt Island, FL (US); Marvin Peplow, Bartlett, IL (US)

Correspondence Address: Clifford Kraft, 320 Robin Hill Dr., Naperville, IL, 60540, US

(21) Appl. No.: 11/986,554

(22) Filed: Nov. 21, 2007

Related U.S. Application Data
(60) Provisional application No. 60/860,908, filed on Nov. 24, 2006.

(51) Int. Cl. B29C 65/00; E04H 7/02

(52) U.S. Cl. 428/36.1; 156/250

(57) ABSTRACT

A fabricated composite tank or cell for the purpose of fuel containment made up to form a unique blend, using existing composite materials and assembled in such a manner as to resist fuel hydrocarbon migration through the tank structure. A blend of nanomer or nano sized clay particles into a polyester, vinyl ester resin is used as a barrier coating to achieve a hydrocarbon migration reduction for pleasure boat fuel containment purposes. The tank is fabricated in such a manner so as to be able to meet the rigorous mechanical strength parameters as outlined for US pleasure boats.

This application is related to and claims priority from U.S. Provisional Patent application No. 60/860,908 filed Nov. 24, 2006. Application 60/860,908 is hereby incorporated by reference.

### BACKGROUND

1. Field of the Invention

The present invention relates to marine and other fuel tanks and more particularly to fabricated composite fuel tanks.

2. Description of the Prior Art

Fuel tanks for pleasure boats manufactured in the United States are built in accordance with 33 CFR 183.510 At present manufacturers utilize aluminum, cross-linked polyethylene or vinyl ester fiberglass as viable materials for tank construction. Although not extensively documented, aluminum fuel tanks corrode at an uncomfortable rate. The United States Coast Guard, realizing safety issues associated with fuel leaks, commissioned a study by the Underwriter's Laboratory in 1994 that concurred and identified this as problem. Additionally cross-linked polyethylene and existing vinyl ester fuel tanks have an issue with fuel permeation and subsequent hydrocarbon migration to atmosphere at environmentally unsafe levels.

It would be advantageous to have a fuel containment method and system that prevented migration of hydrocarbons to the atmosphere and was resistant to corrosion.

### SUMMARY OF THE INVENTION

The present invention relates to a composite structure and process for fuel tank fabrication. The system of the present invention uses assembled, pre-cut closed cell urethane foam sheets with structural urethane adhesive, where the assembled tanks are coated inside and out with a nano sized clay hydrocarbon barrier housed in a vinyl/poly ester matrix. The exterior can be reinforced with fiberglass weaved mat and gel coated for aesthetics. This fabricated tank can be easily reinforced so as to meet or exceed the criteria as specified in H-24 ABYC (American boat and yacht council) and 33 CFR 183.510 standards for fuel systems and our introduction of nano particles of clay will reduce the hydrocarbon migration to the lower levels today being achieved by the automotive industry.

### DESCRIPTION OF THE DRAWINGS

Attention is now directed at several figures to better understand the present invention:

FIG. 1 is a cut-away side view of a fuel tank. On the top of the tank is a stainless steel plate that houses the fill and vent fittings required to fill the tank and vent the fuel vapors, a fuel withdrawal tube and a fuel level sensor.

FIG. 2 shows a closer view of the tank, depicting a corner section of the fuel tank fabricated structure. This view also indicates the composite make up in the order needed to achieve the hydrocarbon containment and mechanical strength.

FIG. 3 is a block diagram of a process for creating a hydrocarbon resistant composite.

FIG. 4 is a block diagram of a process for fabricating a composite fuel tank.

Several illustrations and drawings have been presented to better aid in understanding the present invention. The scope of the present invention is not limited to what is shown in the figures.

### DESCRIPTION OF THE INVENTION

The composite tanks of the present invention can be fabricated using a high-density closed cell urethane glass fiber reinforced composite sheet as a primary building block. Incorporating around 5% nanomer or nano sized treated clay particles/platelets into structural urethane adhesive provides a tank with a fuel resistant fastening medium. Introducing around 5% nanomer into a poly vinyl ester resin matrix retards the migration of hydrocarbons through the fuel tank walls and provides the tank interior and exterior coating.

The nanomer platelets are plate shaped particles that are typically 3-4 microns in size. The platelets lie together similar to pages in a book, and with around 5% saturation, the clay provides a treacherous path at a molecular level that retards the migration of hydrocarbon molecules through the compound. Coated urethane sheets also provide individual tank interior components or slosh baffles, when applicable, assembled onto isophthalic, nano treated polyester pultrusion mandrels also held together with the around 5% nano treated urethane adhesive. Once fully assembled, the tank can be coated with fiberglass reinforced around 5% nano treated vinyl/poly ester resin sufficient for H-24 ABYC (American boat and yacht council) and 33 CFR 183.510 standards for fuel systems mechanical strength requirements. A final gel coat finish may be applied for aesthetics. It should be noted that from 2% to 8% of clay can be used to treat the polyester and the urethane adhesive.

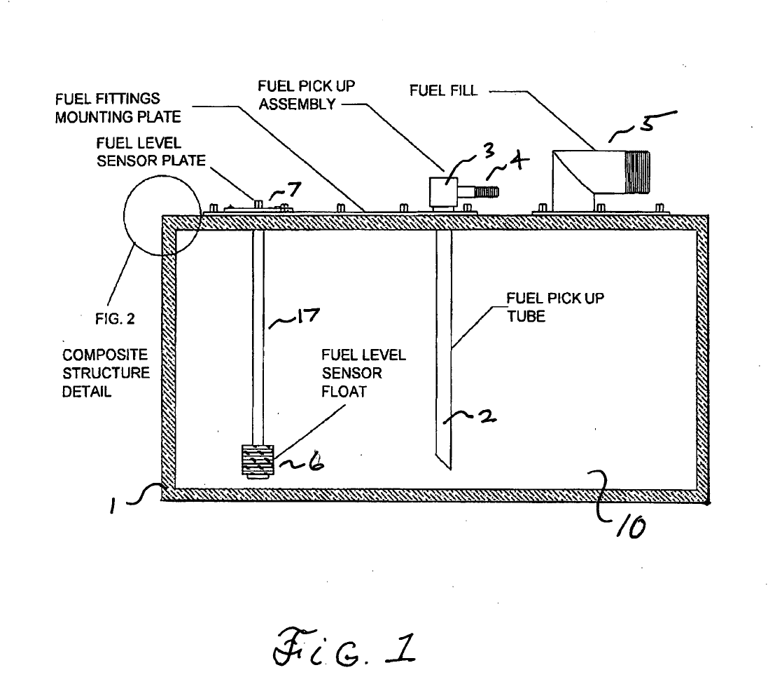

FIG. 1 shows a cross-section of an embodiment of a fuel tank 1 of the present invention. A fuel holding area 10 is made of the composite material described above. The finished tank contains a fuel pick-up tube 2 with a pick up assembly 3 and a fuel line connection 4. A fuel filler port 5 runs into the top of the tank. A fuel sensor sender or float is held in the bottom of the tank with a rod 7 that is clamped onto the tank with a fuel level sensor plate 17.

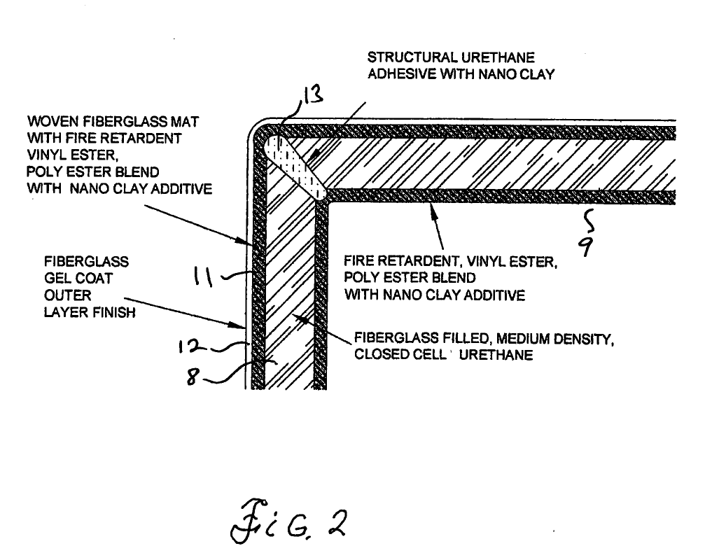

FIG. 2 shows a detail of the composite material that is used to make the tank. The center of the structure contains fiberglass filled, medium density, closed cell urethane 8. The inside wall 9 is made from a fire retardant, vinyl ester/polyester blend with a nano clay additive. The outer wall 11 is woven fiberglass mat with fire retardant vinyl ester polyester blend with nano clay additive. An outer cover 12 of fiberglass gel coat provides outside protection. Structural urethane adhesive 13 with nanomer clay can be used to bond the structure together.

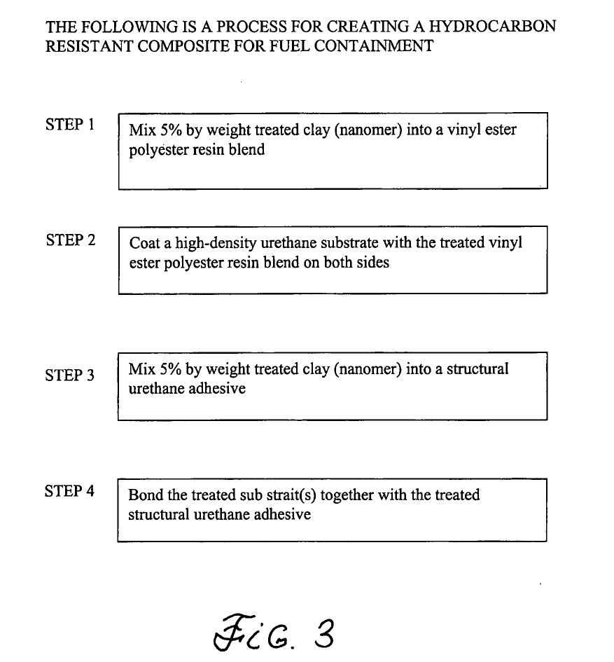

FIG. 3 shows a process for creating the hydrocarbon resistant composite used in the tank construction of the present invention. First around 5% by weight of treated clay nanomer is mixed into a vinyl ester polyester resin blend. Next a high-density urethane substrate is coated on both sides with the treated vinyl ester polyester resin blend. Then around 5% by weight of the treated clay nanomer is mixed into a structural urethane adhesive. Finally the treated substrates are bonded together with the treated structural urethane adhesive. The clay nanomer is similar to products that can be purchased from Nanocor of Arlington Heights Ill.

It should be noted that while the above example used around 5% by weight of clay nanomer, other percentages by weight are within the scope of the present invention. In particular, from around 2% to around 8% by weight of clay can be used. If too much clay is used, the composite could crack or exhibit other undesirable properties. If too little clay is used, the composite may not perform as desired.

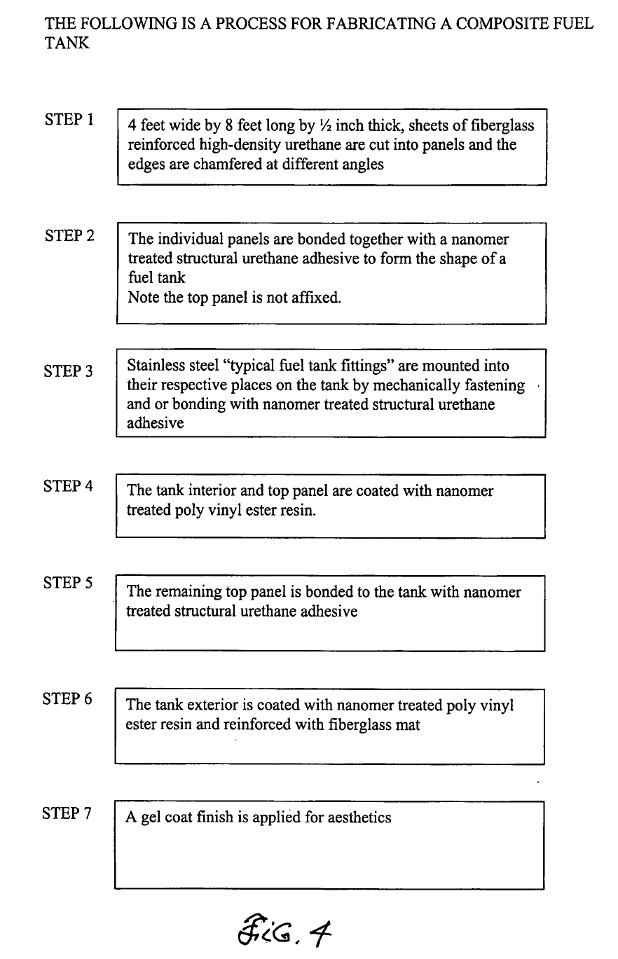

FIG. 4 shows the steps in forming a fuel tank from the composite. The particular example in FIG. 4 specifies materials of a particular size. This is for example only. Any size materials may be used and are within the scope of the present invention.

Several descriptions and illustrations have been provided to better aid in understanding the present invention. One with skill in the art will realize that numerous changes and variations are possible within the spirit of the present invention. Each of these changes and variations is within the scope of the present invention.

We claim:

1. A fabricated composite tank for the purpose of fuel containment comprising a fuel cavity, filler tube and fuel pickup assembly, wherein said fuel cavity has walls comprising a composite with a fire-retardant inner surface made by adding around 5% by weight nanomer or nano sized clay particles into a vinyl ester polyester resin blend; a center layer of fiberglass filled medium density, closed cell urethane, and an outer layer comprising a woven fiberglass mat with fire retardant vinyl ester polyester blended with around 5% by weight nanomer or nano sized clay particles, said outer layer used as a barrier coating to achieve hydrocarbon migration reduction.

2. The fabricated composite tank of claim 1 further comprising a fiberglass gel coat outer finish layer.

3. The fabricated composite tank of claim 1 further comprising a fuel sensor.

4. A fabricated composite tank for the purpose of fuel containment comprising a fuel cavity, filler tube and fuel pickup assembly, wherein said fuel cavity has walls comprising a composite with a fire-retardant inner surface made by adding from around 2% to around 8% by weight nanomer or nano sized clay particles into a vinyl ester polyester resin blend; a center layer of fiberglass filled medium density, closed cell urethane, and an outer layer comprising a woven fiberglass mat with fire retardant vinyl ester polyester blended with from around 2% to around 8% by weight nanomer or nano sized clay particles, said outer layer used as a barrier coating to achieve hydrocarbon migration reduction.

5. The fabricated composite tank of claim 4 further comprising a fiberglass gel coat outer finish layer.

6. The fabricated composite tank of claim 4 further comprising a fuel sensor.

7. A method of making a fuel tank comprising the steps of:
cutting a plurality of fiberglass reinforced high-density urethane panels for top, bottom and sides of a fuel tank;
bonding said sides and bottom panels together to form a tank using a nanomer-treated structural urethane adhesive, set tank having a interior and an exterior;
mounting metal tank fittings onto the top panel mechanically or by bonding with a nanomer treated structural urethane adhesive;
coating the interior of said tank and the top with a nanomer treated polyvinyl ester resin;
boding the top onto said tank using a nanomer treated structural urethane adhesive;
coating the exterior of the tank with a nanomer treated polyvinyl ester resin;
reinforcing the exterior of the tank with a fiberglass mat.

8. The method of making a fuel tank of claim 7 further comprising applying a gel coat finish to the tank exterior.
